(19) United States
(12) Patent Application Publication
(10) Pub. No.: US 2006/0218174 A1
(43) Pub. Date: Sep. 28, 2006

(54) Method for coordinating schema and data access objects

(76) Inventors: John L. Cook III, Southborough, MA (US); Louis M. Colon JR., Bolton, MA (US); Malini K. Bhandaru, Sudbury, MA (US); Kathy Kaminski, Marlborough, MA (US)

Correspondence Address: MCGLEW & TUTTLE, PC, P.O. BOX 9227, SCARBOROUGH STATION, SCARBOROUGH, NY, 10510-9227, US

(21) Appl. No.: 11/087,875

(22) Filed: Mar. 23, 2005

(51) Int. Cl. G06F 7/00

(52) U.S. Cl. 707/102

(57) ABSTRACT

Two techniques are commonly used when developing database applications. First, script files containing batched database commands are frequently used to establish the schema of database tables. Second, the software design pattern “Data Access Objects” are sometimes used to contain programmatic database requests while providing an application programmer a more abstract, easier to use interface to the database. Both of these techniques require essentially the same information: an understanding of the organization of particular database tables. The present invention reduces the labor associated with maintaining synchronicity between these two components by a method that allows both the schema and the format of the Data Access Object to be determined by evaluating the properties of an object to be stored in the database.

### FIELD OF THE INVENTION

The present invention relates in general to a method and apparatus for storing digital information, and in particular, to storing digital information in relational databases via the methodology of the Data Access Object software design pattern.

### BACKGROUND OF THE INVENTION

Many organizations collect large amounts of data such as employee data, customer data, product data, etc. This data can be useful if presented in the right form to the right people at the right time. The data is usually stored in a computer database. For example, a school will collect data about students, such as an address, birthday, social security number, previous schooling, phone numbers, etc. The school also collects data about the faculty, such as address, experience, start date, and courses they can and are teaching. The school can also collect data on the different courses being offered, who teaches the courses, who is signed up as a student for the courses, and where the courses are held.

All this data is usually stored in a database. General purpose computer applications manipulate the data and often use a specialized computer application known as a database server to store the data. There are several advantages achieved by using a database. First, application data, also known as objects, may be persisted between use when the total amount of data stored in the database exceeds the resources required to keep all data resident within the local memory. Second, objects may be persisted between execution of an application and/or invocations of the machine upon which they are executed. Third, a plurality of computer applications that work together for some common purpose can share data with complex relationships.

Most modern relational databases are first designed and configured, and then they are used by applications. During the design and configuration phase, database instances are created, and tables are created within those database instances. While it is possible for database administrators to use a command line interface to construct database tables, it is a more common practice to build script files which execute the command line interface as a batch operation. This practice facilitates the debugging of the initial database tables as well as the recovery of lost databases. Information such as table names, column names, column types and relationships are defined by these database commands.

Once a database has been designed and implemented, the second phase may commence, namely the use of the database. When an object-oriented computer language such as C++ or Java is used, application data structures tend to be represented as a collection of properties defined as a class. In most cases, it is the non-transient values of class instances which developers are interested in persisting in a database. To achieve the storage and retrieval of class instance properties with respect to database tables, special code must be written. This code takes into account the structure of the database as designed, as well as the association between database columns and class instance properties. It is important to note that a change to the schema of the database will usually result in a change to this process and vice versa.

There are many different database client applications which a developer can use to store, modify and retrieve data from a database server application. These different client applications each have their own specific language or commands to manage the data. There are also many different database server applications each with their own specific language or commands.

Different types of organizations have different types of data, and often collect and need the data in different forms. Very often the people entering the data, and needing the data, are only slightly computer literate, or do not have sufficient time to prepare the data in the proper form. Therefore separate database client applications are needed to collect and present the data. It is desirable to make the client applications, that present the data, be very easy to use, and anticipate the needs of the operator. As the amount of data increases and as the different ways in which the data is to be presented increases, the database client applications become more and more complicated to create. One way to make writing the data base client easier, is to make generic commands for storing, modifying and retrieving the data from different database applications.

In recent years a software design pattern known as Data Access Objects (DAO) has emerged. When employing this pattern in software designs, special DAO classes are developed that encapsulate the design details of the database as well as the procedure calls used to effect changes in the database. This technique is useful when a development team is made up of application and database specialists. By using DAO objects, application developers are able to focus on application development without undue concern for database interaction. Although advantageous in some respects, the DAO introduces yet another layer of coordination that must be considered as database and/or class structures change.

### SUMMARY OF THE INVENTION

It is an object of the present invention to allow the objectives of DAO while eliminating two of the three points of maintenance associated with changing data structures: schema and the DAO itself. That is to say, a change (addition, modification or removal) to class design is discovered and accommodated by a generic DAO object, and that generic DAO object has the ability to reconfigure the underlying database.

The present invention accomplishes this by evaluating classes as they are referenced through the DAO. As new classes are seen, a schema for that class is programmatically created and the database structure is changed. If the structure of a class has changed, the generic DAO compares the structure of the class properties with the database and effects whatever changes are required to the schema of the database to make the two agree. By providing general purpose methods for functions typically implemented in DAO objects, such as add, get, getMany, update and remove, this generic DAO object is able to interact with all classes persisted to the underlying database.

In a preferred embodiment of the present invention, a server application manages the database, and a client application sends data to the database server application, the database client reads data from the server application, and the client application manipulates the data for presentation to a user.

The client application organizes the data into separate collections, for example a plurality of tables, each with columns and rows. As a further example, a school may have a table for student information, where each row of the table is for a different student, and the columns describe different information for each student, such as name, social security number, address, etc. The school can have another table for course information with each row describing a different course and the columns describing different information about the course.

The client application describes these separate collections or tables by creating a class for each table. The class indicates to which collection or table the class is associated with. The class also indicates the different items or columns in the associated table.

When the client application wants to add data to the database, the client application creates an object based on the appropriate class. For example, if an additional student is to be added to the student table, a student object is made based on the class for the student table. The student object includes local storage for the different items of information of the student. The client application will process the student object and send the database instructions to the database server.

Prior to the present invention, custom methods would need to be established for each table and/or class so that the data in the objects could be entered into the appropriate table. The present invention includes a software module in the client application which analyzes the object and determines the table to which the object belongs. The software module analyzes the database to determine if the database includes that table. If the database does not include that table, the software module creates a table in the database corresponding to the table to which the object belongs. Once the database includes the table for the object, the software module analyzes the object to determine the different items of information or columns in the object. The software module then compares the columns in the object with the columns in the corresponding table. The software module adjusts the columns in the table to match the columns in the object. The software module is preferably created using the Data Access Objects (DAO) pattern. DAO's are already known to the person of ordinary skill in the art of databases, and therefore no further explanation is necessary concerning DAO's.

According to the DAO pattern, the software module is also written with classes and objects. A datasource class is created to process data objects such as the student object. This datasource class has general-purpose commands which operate on a data object. The general-purpose commands can add, read, modify and delete the data of the data object in the database. These general-purpose commands need to know the tables and the columns of the different data classes created by the client application, and present in the database. These general-purpose commands also need to know how to add, read, modify and delete the tables and columns. The present invention provides further subclasses under the datasource class, called the classmetadata which include general commands for processing the tables. The present invention has subclasses to the classmetadata called membermetadata which includes general commands for processing the columns of the tables. In this way, a datasource class can be written to process all data objects for a database.

The developer of a client application only needs to create a class for each of the tables that the developer desires. The class for each table includes sufficient information to describe how the table is to be arranged. The present invention extracts this information from the class and configures a table accordingly, if the table is not already configured. The developer of the client application does not need to know the specific commands for the server application once the datasource class, the classmetadata and the membermetadata are created according to the present invention. The client developer only needs to create the classes, and the corresponding tables will be created automatically.

This is especially advantageous during the development stages of a client application. During initial development, the arrangement of the database often changes frequently. With the present invention, the developer only needs to change the classes in the client application, and the proper tables in the database will be created the next time the client application is executed. Only one change needs to be made, not the many changes such as for the DAO and database schema. Furthermore, the corresponding tables are only created when they are needed. The tables do not need to be created ahead of time by the developer, which saves the developer time, and allows the developer to concentrate on how the data is to be manipulated for presentation to the user. It is also possible with the present invention to have the database client access several different database servers at the same time. The developer does not need to know the specific commands for each server once the datasource classes are provided.

It is often desirable to hash or sort tables based on one or more of the columns: collectively a key. For example, if each student is given a student ID number, the student table can have all the rows sorted by the ID number. In this way, when the data for a particular student needs to be modified, it is very easy to find the row containing that student's data. The datasource class can include methods for sorting a table based on one or more columns. In a particular embodiment of the present invention, one or more columns where the name of the column has the word or suffix “ID,” is selected to be used as key fields in the table. When a row of data is to be added to the table, the datasource class can examine the column that is used for sorting, and places the row in the table according to the sort order of that column. Key fields are evaluated by the datasource as new tables are added or modified.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an example set of conventional data in single sheet form;

FIG. 2 is the presentation of the data from FIG. 1 as conventional relational database tables;

FIG. 3a is the object-oriented design for a Java class adhering to the Java Bean standard;

FIG. 3b is the object-oriented design notation for a Java based DAO class;

FIG. 4 is the object-oriented design notation for the major classes associated with the preferred embodiment of the invention;

FIG. 5 is a summary of the state machine associated with fetching a classmetadata instance;

FIG. 6 is a summary of the state machine associated with dynamically creating a database table;

FIG. 7 is a summary of the state machine associated with scanning membermetadata and adding or removing database columns from existing tables as needed;

FIG. 8 is a summary of the state machine associated with building and executing a table insert of a persistent object's properties;

FIG. 9 is a summary of the state machine associated with building a SQL “where” clause based on a template object.

FIG. 10 is a summary of the state machine associated with processing a “get many” request.

### DESCRIPTION OF THE PREFERRED EMBODIMENTS

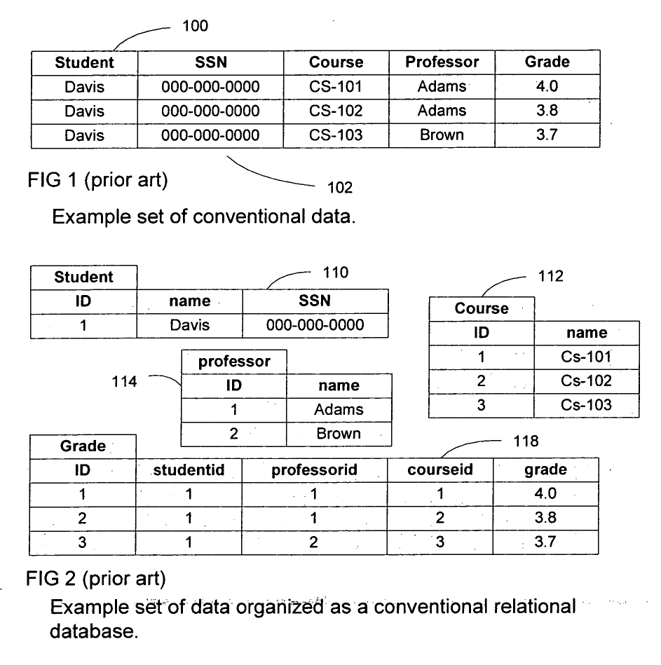

Referring to the drawings, in particular FIG. 1, data associated with a student's classes can be represented in spreadsheet form. When representing data in this form, it is possible for data values to repeat. In this example, both the student name 100 and the social security number will have the tendency to repeat. This can make the database unnecessarily large. A better representation is shown in FIG. 2 where the data is organized into tables. Each student is represented once in the student table 110. Likewise, other components of data have been put in their own tables: course table 112, professor table 114 and grade table 118. In this example, each database table has a key field called ID which is a unique number within the context of the table. This allows the associations to be pulled together in the grade table 118 by its referring to the ID fields in the other tables. These associations or relationships are the essence of relational databases.

To create a table in a database, a schema must be provided. This is typically done via a command line interface. The preferred method for executing these commands is via a script file as a batch job. For example to create the grade table 118 from FIG. 2, the following commands would need to be entered on the database command line:

CREATE DATABASE SCHOOL;

USE SCHOOL;

CREATE TABLE StudentGrade {

id BIGINT NOT NULL AUTO_INCREMENT PRIMARY KEY,

studentId BIGINT NOT NULL,

professorId BIGINT NOT NULL,

courseID BIGINT NOT NULL,

grade FLOAT NOT NULL

};

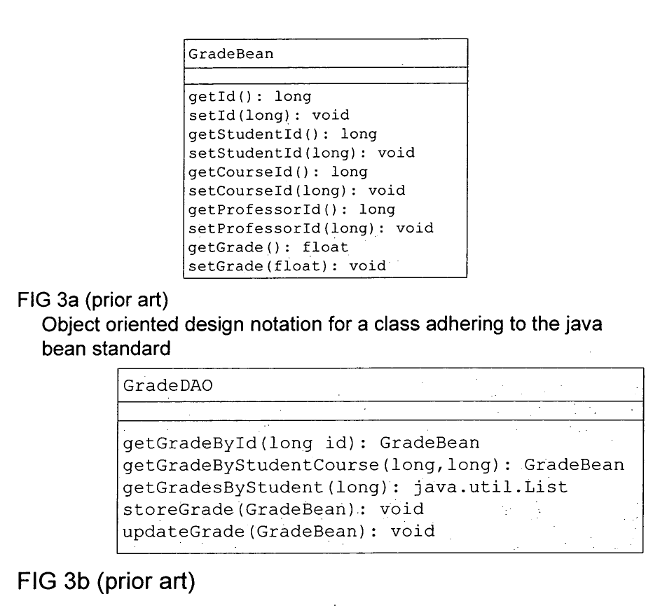

In the preferred embodiment using the Java programming language, this table would be represented by the Java class shown in FIG. 3A. This class adheres to the Java bean standard. The Java Bean standard places special significance on method names beginning with “get,” “set,” or “is.” Such methods are considered access methods for the properties. In the previous code, the method “setId” is a setter method for the property “id.” Likewise, the “getId( )” method is a getter method for the same property. This is significant because Java has built-in support for processing the properties of a class that follows the bean standard. The technique of extracting getter and setter information from a bean is referred to as introspection, which is a known method of the Java programming language and within the ability of those skilled in Java. Therefore, no further explanation of introspection is needed in this specification.

Referring to FIG. 3B, a Data Access Object (DAO) could be written to encapsulate the implementation details of interacting with the database when dealing with students and their grades. Having DAO classes allows application developers to focus on their work in developing applications without concern for how to interact with the database. In this case, an application developer could manipulate GradeBean objects in the database without needing to write database access code. The database access code is implemented within the DAO itself.

Using these techniques, the same information about the names and types of the properties associated with a bean needs to be entered three times: in the schema, in the bean class and in the DAO. Likewise, whenever a change is made to any one of these components, a similar change must be made in the other two.

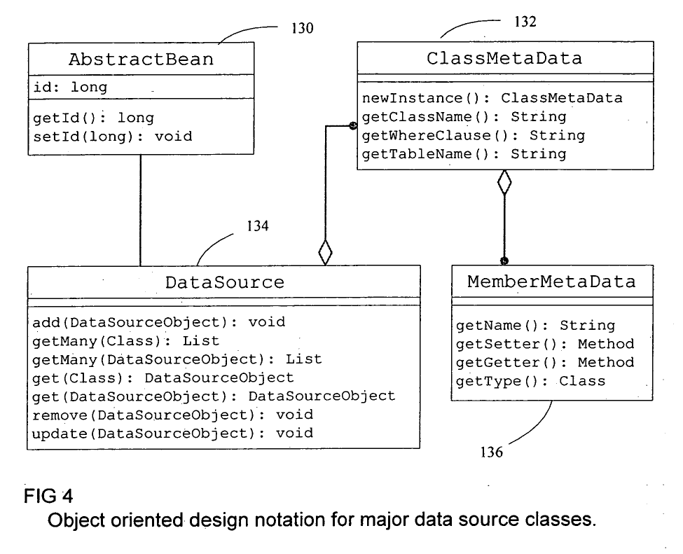

Referring to FIG. 4, the present invention optimizes the process of developing and maintaining a database system, via the introduction of the DataSource class 134. The DataSource class is in essence a generic DAO. It provides the standard functions that most application developers need to have when interacting with persisted objects: add, modify and delete. An instance of the DataSource class 134 is capable of performing these operations on an instance of a class that extends the abstract bean class 130. The abstract bean 130 is an abstract class that provides the generic ID property for each bean to be stored in the DataSource 134. In order to store a bean in the DataSource, it must extend (or inherit from) the Abstract bean 130.

A DataSource instance maintains information about each type of abstract bean 130 via a ClassMetaData 132 class object. The ClassMetaData 132 is therefore an aggregate of, or belongs to, the DataSource 134, and each DataSource 134 has one ClassMetaData object for each Abstract bean 130 class derivative it has seen. The ClassMetaData 132 describes the abstract bean 130 at a high level. The individual properties, their “getters,” “setters,” name and type information is maintained in a list of MemberMetaData 136 classes objects. Therefore, the MemberMetaData 136 is an aggregate of, or belongs to, the ClassMetaData 132, and there is one MemberMetaData class 136 object per property of the associated abstract bean 134.

Referring to FIG. 5, as a DataSource instance is presented an abstract bean derivative, it must fetch the associated ClassMetaData instance. First, the DataSource will attempt to find the ClassMetaData instance in its local cache 150. If the instance is not in the cache, the DataSource object checks 152 to see if the underlying database has a table associated with the bean. If such a table is not found, it is created 154. (The technique for creating a database table is discussed below.) In either case, the bean is then scanned 156 to create an instance of the ClassMetaData, and that instance is placed 158 in the local cache for future reference. (The technique for scanning a bean is discussed below.)

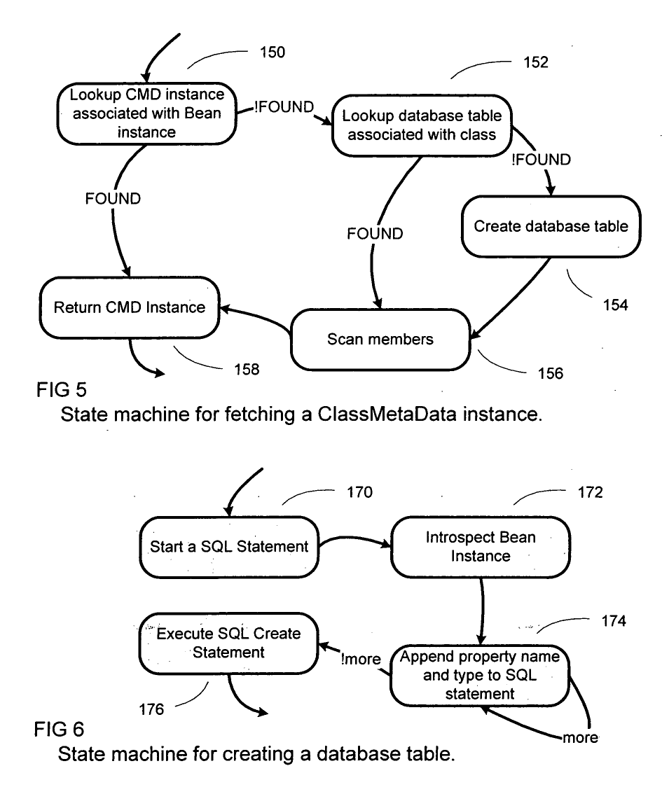

Referring to FIG. 6, a database table is created based on a bean by first starting a SQL CREATE statement 170. Next, an introspection of the bean class is performed 172. The result of the introspection is a list of bean properties and their types. Then the list of properties is iterated, and the name and type of each property is appended to the SQL CREATE statement 174. In some cases an algorithm is applied to determine if a column (representing a property) in the database should be a key field. In the preferred embodiment, this algorithm consists of looking for the work or suffix “id” in the property name. Finally, the SQL CREATE statement is executed against the database 176. At this point, a table will exist in the database that is suitable for storing the properties of the bean.

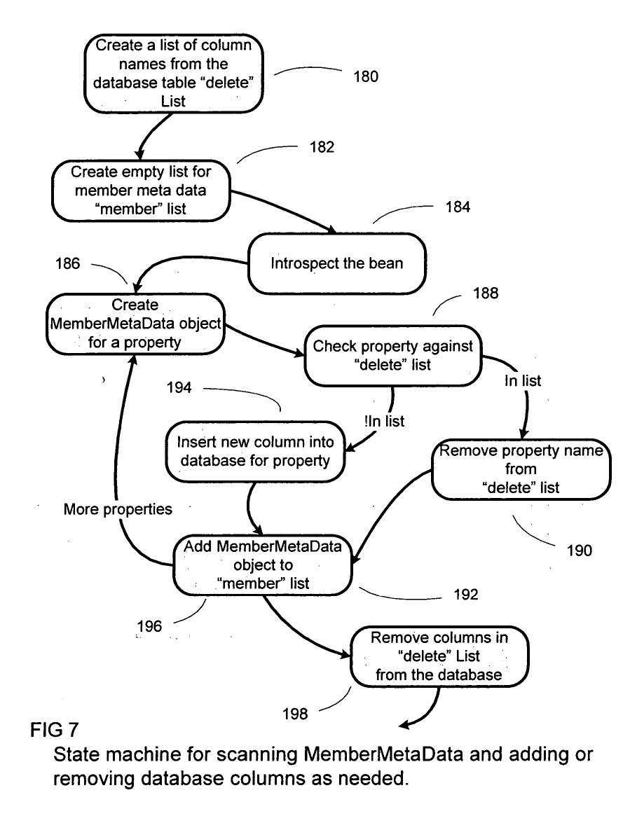

Referring to FIG. 7, the scanning process is used to populate the list of MemberMetaData instances maintained by the ClassMetaData instance associated with a bean. It has the additional benefit of updating the schema of a database table to match the bean whenever new properties are added to the bean or old properties are removed.

In order to adjust an existing database table, the schema of the database table must be understood; therefore the first step in the scanning process is to create a list of column names and their type for each column in the database table associated with the bean at hand 180: the “delete” list. Next, an empty list is created 182 to hold instances of MemberMetaData associated with each property of the bean: the “member” list. At this point an introspection of the bean is performed 184. Again, the introspection will result in a list of bean properties: the “property” list. The resulting “property” list is iterated, and for each bean property, the following steps are taken. First, a MemberMetaData object is instantiated 186 for the property. Second, the “delete” list is checked 188 for a corresponding entry for the property. If the property is in the “delete” list, it is removed 190 from the “delete” list. However, if the property is not in the “delete” list, it is a new property, and a SQL INSERT COLUMN command is executed against the database to add 194 a new column for the new property. In both cases, the newly created MemberMetaData object is added to the “member” list. Finally, once all properties in the “property” list have been processed, a SQL DELETE COLUMN command is executed against the database to remove the properties remaining in the “delete” list. Once all of the scanning steps have been completed, the database schema will agree with the ClassMetaData representation of the bean, and the ClassMetaData object will contain a valid list of MemberMetaData objects.

The process of creating database tables and scanning beans described above will be executed once per DataSource 134 upon the DataSource 134 seeing an Abstract bean 130. This is due to the fact that the MemberMetaData objects are cached in ClassMetaData objects, and the ClassMetaData objects are cached in the DataSource. Since DataSource objects tend to live for the duration of the application, these discovery and maintenance tasks are typically only performed once per application invocation.

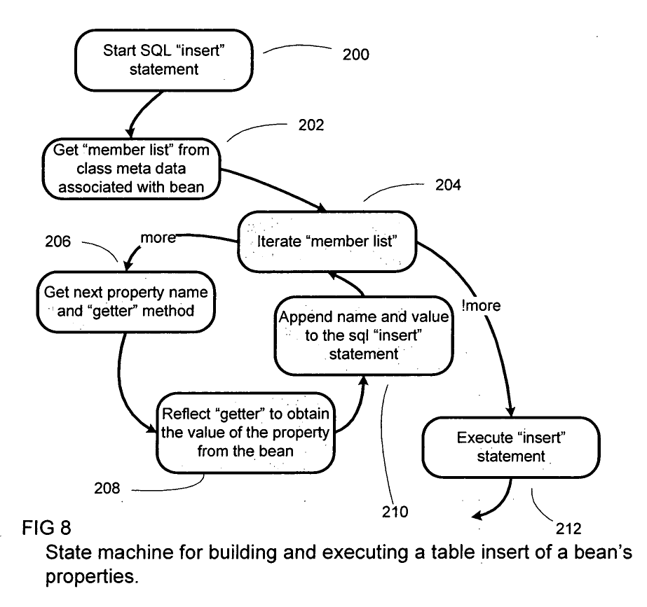

Referring to FIG. 8, once a bean is known to a DataSource 134, an application can use the DataSource 134 to persist an instance of that bean. The first step in this process is to begin creating an SQL INSERT statement 200. Next the list of MemberMetaData objects is retrieved 202 from the ClassMetaData object associated with the bean. This list is iterated 204, and the following steps are performed for each property. First, the property name and getter method are obtained 206. Second, reflection is used to execute the getter method on the bean and the value associated with the property is obtained 208. (Reflection is a method of indirectly invoking a method by name and object reference to obtain or manipulate a property of an object and is known to individuals skilled in Java.) Next, the name and value are appended 210 to the SQL INSERT statement under construction. Once all of the properties have been processed, the SQL INSERT statement is executed 212 against the underlying database. At this point, there will be a persisted representation of the bean within the database. A similar technique is used when updating an existing persistent representation of an existing bean instance.

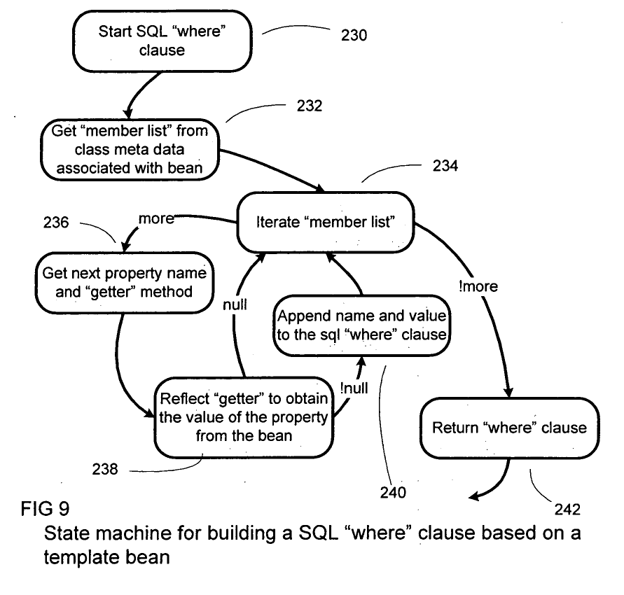

Referring to FIG. 9, when retrieving persisted bean instances from the database, it is often valuable to establish some criteria for the record or records obtained. The preferred embodiment of the present invention utilizes a template for establishing this criterion. A template is in essence an instance of the bean at hand with certain properties established. Properties which have values that are not initialized are not considered in this process. First, an SQL WHERE clause is started 230. Next the list of MemberMetaData objects is retrieved 232 from the ClassMetaData object associated with the template bean. This list is iterated 234, and the following steps are performed for each property. First, the property name and getter method are obtained 236. Second, reflection is used to execute the getter method on the template bean and the value associated with the property is obtained 238. If the value of the property is undefined, iteration continues with the next property. However, if the value of the property is defined, the name and the value of the property are appended 240 to the SQL WHERE clause under construction. Once all of the properties have been processed, the SQL WHERE clause is complete 242 and can then be used in the construction of SQL statements requiring WHERE clauses.

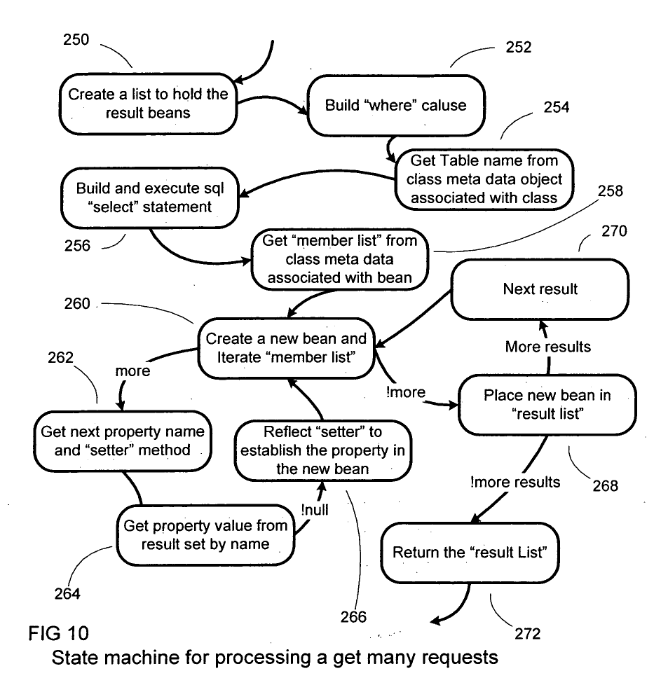

Referring to FIG. 10, once database instances of persisted objects are in the database, applications will need the ability to retrieve these instances. Populating bean instances from persisted database tables takes many forms, so the more complex form of getting a plurality of object matching a certain criterion will be described. First, an empty list to hold the resulting beans is created 250. Next, an SQL WHERE clause is constructed 252 as described above based on a template bean. Next, the table name is obtained from the ClassMetaData object associated with the template bean. Next, an SQL SELECT statement is constructed 256 for the table and the SQL WHERE clause at hand. At this point, there will be a result set returned by the database which contains the data associated with the result beans to be constructed. For each entry in the result set, the MemberMetaData list is obtained 258 from the ClassMetaData object. Next, a new bean instance is created to hold the values from the result set, and the properties are iterated 260 based on the MemberMetaData list. For each property, the name and setter method are obtained 262. Then the value of the property is obtained 264 from the result set. Reflection 266 is used to invoke the setter with the value to establish the value of the property within the newly created bean. Once each of the properties has been handled for the bean, that bean is placed 268 on the results list. Once each of the result sets has been processed and all the beans have been placed on the result list, the result list is returned 272.

The terms line, row, table, column are used in this specification to describe different collections of data and are used to assist the reader in understanding how the present invention relates to a database using a two-dimensional table or sheet format. These terms are not intended to be limited to collections where data must be in line, row, table or column format, or the database must be two-dimensional. Instead these terms are only a preferred form of the data collection, and the present invention can be used with many different forms of data collections.

The use of terms with mixed upper and lower case has been used to make the application easier to read and in accordance with the conventions used in major object oriented programming languages such as Java and C++. The mixed case does not imply any further limitations on the terms.

While specific embodiments of the invention have been shown and described in detail to illustrate the application of the principles of the invention, it will be understood that the invention may be embodied otherwise without departing from such principles.

What is claimed is:

1. A database method comprising the steps of:
providing a collection of data;
providing a database for storing the collection of data;
describing individual items of the collection in a data class;
describing methods in the data class for accessing the individual items;
creating a data object having local storage for the individual items in the data class according to said describing of the items;
introspecting said data class to determine a portion of said database corresponding to said data class.

2. A database method in accordance with claim 1, wherein:
said introspecting includes determining areas said portion of said database should have.

3. A database method in accordance with claim 2, wherein:
said portion of said database is a table;
said areas of said portion are columns.

4. A database method in accordance with claim 1, further comprising:
managing the database with a server application;
manipulating the data with a client application, said client application creating the data class and data object, said client performing said introspecting and said introspecting including introspecting the object to determine the portion of the database.

5. A database method in accordance with claim 1, further comprising:
comparing portions of the database with a portion associated with the data class;
determining if the database includes the portion associated with the data class;
adding the portion associated with the data class to the database if the database does not have the portion.

6. A database method in accordance with claim 5, further comprising:
determining what areas said portion of said database should have in said introspecting;
comparing areas of the portion of the database with areas of the data-class;
modifying the areas of the database to correspond to the areas of the data class.

7. A database method in accordance with claim 1, further comprising:
creating a datasource class, said the datasource class including methods for transferring the data between the data object and the database.

8. A database method in accordance with claim 7, further comprising:
creating a classmetadata class as a subclass of the datasource class, said classmetadata class including methods for managing the portions of the database.

9. A database method in accordance with claim 8, further comprising:
said introspecting including determining what areas said portion of said database should have;
creating a membermetadata class as a subclass of the classmetadata class, said membermetadata class including methods for managing the areas of the portions of the database.

10. A database method in accordance with claim 7, further comprising:
providing a plurality of database server applications;
creating a datasource class, said the datasource class including methods for transferring the data between the data object and the database;
creating a datasource object according to the datasource class for each of said plurality of database servers.

11. A database method in accordance with claim 8, further comprising:
creating a classmetadata object according to the classmetadata class for each portion in the database.

12. A database method in accordance with claim 9, further comprising:
creating a membermetadata object according to the membermetadata class for each area in portions of the database.

13. A database system comprising:
a database including a plurality of portions for storing data, said portions including a plurality of individual areas for storing individual items of data;
a database server including specific instructions for transferring data into and out of said database;
a database client sending data to and receiving data from said database server, said database client including a data class describing a collection of data, a data object having local storage according to said data class for the data in the collection of data, said database client including a datasource class including methods for processing said data object, said methods including introspecting said data object to determine in which of said portions of said database server said data object belongs, and what areas said portion should have.

14. A database system in accordance with claim 13, wherein:
said data class includes methods for entering and reading data into and from said local storage.

15. A database system in accordance with claim 13, wherein:
said methods of said datasource class include creating a new portion of said database based on said data object.

16. A database system in accordance with claim 13, wherein:
said methods of said datasource class include modifying said areas of one of said portions of said database to correspond to said data class.

17. A database system in accordance with claim 15, wherein:
said methods of said datasource class include modifying said areas of one of said portions of said database to correspond to said data class.

18. A database system in accordance with claim 13, further comprising:
a classmetadata class as a subclass of said datasource class, said classmetadata class includes methods for managing said portions of said database server.

19. A database system in accordance with claim 18, further comprising:
a membermetadata class as a subclass of said datasource class, said membermetadata class includes methods for managing said areas of said portions of said database server.

20. A database system in accordance with claim 18, further comprising
a classmetadata object created according to said classmetadata class for each said portion in said database server;
a membermetadata object created according to said membermetadata class for each said area in said portions of said database server.

21. A database system in accordance with claim 15, wherein:
said methods of said datasource class include sorting one of said portions of said database dependent on one of said areas of said one database.

22. A database system comprising:
a data object with individual data items;
a database including a portion for storing data, said portions including a plurality of individual areas for storing the individual items of data;
a datasource class including methods for transferring the data between said data object and said database, said datasource class including a subclass with methods for determining which said areas of said database correspond to the individual items of data in said data object, said subclass also including methods for one of adding, modifying and deleting the individual items of data in said data object to or from said database.

23. A database system in accordance with claim 22, wherein:
said portion of said database is a table;
said areas of said portion are columns;
the individual data items of said data object form a row in said table.
